(19) United States
(12) Patent Application Publication
(10) Pub. No.: US 2023/0156556 A1
(43) Pub. Date: May 18, 2023

(54) METHOD AND APPARATUS FOR USER ASSOCIATION BASED ON FUZZY LOGIC AND ACCELERATED REINFORCEMENT LEARNING FOR DENSE CLOUD WIRELESS NETWORK

(71) Applicant: Industry-Academic Cooperation Foundation, Chosun University, Gwangju (KR)

(72) Inventors: Wooyeol CHOI, Gwangju (KR); Rehenumna Tasnim RODOSHI, Gwangju (KR)

(73) Assignee: Industry-Academic Cooperation Foundation, Chosun University, Gwangju (KR)

(21) Appl. No.: 18/055,113

(22) Filed: Nov. 14, 2022

(30) Foreign Application Priority Data
Nov. 15, 2021 (KR) 10-2021-0156799

(51) Int. Cl. H04W 36/32; H04W 36/00

(52) U.S. Cl. CPC H04W 36/32; H04W 36/00835

(57) ABSTRACT

Provided are a method and an apparatus for user association based on fuzzy logic and accelerated reinforcement learning for a dense cloud wireless network. A method for user association based on fuzzy logic and accelerated reinforcement learning in a dense cloud wireless network according to an embodiment of the present disclosure.

### CROSS-REFERENCE TO RELATED APPLICATIONS

This application claims the priority of Korean Patent Application No. 10-2021-0156799 filed on Nov. 15, 2021, in the Korean Intellectual Property Office, the disclosure of which is incorporated herein by reference.

### BACKGROUND OF THE INVENTION

### Field of the Invention

The present disclosure relates to a method and an apparatus for user association based on fuzzy logic and accelerated reinforcement learning for a dense cloud wireless network, and more particularly, to a method and an apparatus for user association for determining whether to trigger fuzzy logic based handover in a dense cloud wireless network, and determining target RRH based on reinforcement learning.

### Description of the Related Art

The existing cellular network handover policy is based on a received signal strength. The existing handover mechanism may not be suitable for small cell-based C-RAN of a 5G network.

In this case, a connection between a user terminal and RRH is frequently changed, so unnecessary handover may occur in a network.

Frequency handover leads to excessive signaling overhead, low energy efficiency, and network throughput reduction.

A lot of different control parameters should be considered in order to develop an efficient handover mechanism jointly with a received signal.

Various researches for effective handover and reconnection of the user terminal and the RRH are conducted, but it is insufficient.

Another parameter is used in order to reduce a handover number in the network, and six handover events and two handover control parameters are defined according to 3GPP.

In the case of different events, the handover control parameters are adjusted in order to control a handover trigger condition. Handover control parameter optimization and appropriate RRH selection are researched, but two optimizations need to be all integrated in order to maintain network efficiency.

The above-described technical configuration is the background art for helping in the understanding of the present invention, and does not mean a conventional technology widely known in the art to which the present invention pertains.

### SUMMARY OF THE INVENTION

The present disclosure is contrived to solve the above-described problem, and has been made in an effort to provide a method and an apparatus for association based on fuzzy logic and accelerated reinforcement learning in a dense cloud wireless network.

Further, the preset invention has been made in an effort to provide a method and an apparatus for optimizing a handover control parameter called a time-to-trigger (TTT) value based on a fuzzy logic function.

Further, the present disclosure has been made in an effort to provide a method and an apparatus for selecting target RRH so that a connection is maintained longer by using a reinforcement learning model.

Other objects of the present disclosure are not limited to the objects described above, and other objects, which are not mentioned above, will be apparent to those skilled in the art from the following description.

According to an embodiment of the present disclosure, there is provided a method for user association based on fuzzy logic and accelerated reinforcement learning for a dense cloud wireless network, which may include: (a) receiving positional information of a user terminal; (b) determining a movement velocity of the user terminal and a distance between the user terminal and a serving remote radio head (RRH) based on the positional information of the user terminal; (c) determining whether to trigger handover of the user terminal based on the movement velocity of the user terminal and the distance between the user terminal and the serving RRH; and (d) performing handover to a target RRH from the serving RRH of the user terminal based on whether to trigger the handover.

In an embodiment, step c) above may include adjusting a time-to-trigger (TTT) value indicating a connection maintenance time between the user terminal and the serving RRH after a received signal strength for a signal received from the user terminal is smaller than a threshold by applying the movement velocity of the user terminal and the distance between the user terminal and the serving RRH to a fuzzy logic function, and determining whether to trigger the handover of the user terminal based on the adjusted TTT value.

In an embodiment, step (d) above may include calculating a proximity of the user terminal and the serving RRH based on the distance between the user terminal and the serving RRH and a coverage of the serving RRH, and calculating a directional displacement of the user terminal for the serving RRH based on a change amount of the distance between the user terminal and the serving RRH and the movement velocity of the user terminal, determining the target RRH among multiple candidate RRHs by applying the proximity of the user terminal and the serving RRH and the directional displacement of the user terminal to a reinforce learning model, and performing the handover to the determined target RRH.

In an embodiment, step (d) above may include generating a virtual reward of the RL model based on an expected location of the user terminal, and the proximity of the user terminal and the serving RRH and the directional displacement of the user terminal, converging a virtual learning model by mapping a virtual reward and an actual reward of the RL model, determining the target RRH among the multiple candidate RRHs based on the converged RL model, and performing the handover to the determined target RRH.

According to another embodiment of the present disclosure, there is provided an apparatus for user association based on fuzzy logic and accelerated reinforcement learning for a dense cloud wireless network, which may include: a communication unit receiving positional information of a user terminal; and a control unit determining a movement velocity of the user terminal and a distance between the user terminal and a serving remote radio head (RRH) based on the positional information of the user terminal, determining whether to trigger handover of the user terminal based on the movement velocity of the user terminal and the distance between the user terminal and the serving RRH, and performing handover to a target RRH from the serving RRH of the user terminal based on whether to trigger the handover.

In an embodiment, the control unit may adjust a time-to-trigger (TTT) value indicating a connection maintenance time between the user terminal and the serving RRH after a received signal strength for a signal received from the user terminal is smaller than a threshold by applying the movement velocity of the user terminal and the distance between the user terminal and the serving RRH to a fuzzy logic function, and determine whether to trigger the handover of the user terminal based on the adjusted TTT value.

In an embodiment, the control unit may calculate a proximity of the user terminal and the serving RRH based on the distance between the user terminal and the serving RRH and a coverage of the serving RRH, and calculate a directional displacement of the user terminal for the serving RRH based on a change amount of the distance between the user terminal and the serving RRH and the movement velocity of the user terminal, determine the target RRH among multiple candidate RRHs by applying the proximity of the user terminal and the serving RRH and the directional displacement of the user terminal to a reinforce learning model, and perform the handover to the determined target RRH.

In an embodiment, the control unit may generate a virtual reward of the RL model based on an expected location of the user terminal, and the proximity of the user terminal and the serving RRH and the directional displacement of the user terminal, converge a virtual learning model by mapping a virtual reward and an actual reward of the RL model, determine the target RRH among the multiple candidate RRHs based on the converged RL model, and perform the handover to the determined target RRH.

Specific matters for achieving the above objects will be clearly referred to in detail to be described in detail with the accompanying drawings.

However, the present disclosure is not limited to an embodiment disclosed below but may be implemented in various different shapes and the present disclosure just completes a disclosure of the present disclosure and is provided to completely inform a scope of the present disclosure to those skilled in the art (hereinafter, a “conventional technical expert”).

According to an embodiment of the present disclosure, QoS of a user terminal can be maintained and connection duration can be maintained to be longer, and the number of handover times can be minimized.

The effects of the present disclosure are not limited to the aforementioned effects, and provisional effects to be expected by the technical features of the present disclosure will be clearly understood from the following description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other aspects, features and other advantages of the present invention will be more clearly understood from the following detailed description taken in conjunction with the accompanying drawings, in which:

FIG. 1 is a diagram illustrating a system for user association based on fuzzy logic and accelerated reinforcement learning in a dense cloud wireless network according to an embodiment of the present disclosure;

FIG. 2 is a diagram illustrating a fuzzy logic function based TTT value optimization process according to an embodiment of the present disclosure;

FIG. 3A is a diagram illustrating a membership function graph for a distance input between a user terminal and serving RRH according to an embodiment of the present disclosure;

FIG. 3B is a diagram illustrating a membership function graph for a movement velocity input of a user terminal according to an embodiment of the present disclosure;

FIG. 3C is a diagram illustrating a membership function graph for a TTT value according to an embodiment of the present disclosure;

FIG. 4 is a diagram illustrating a method for user association based on fuzzy logic and accelerated reinforcement learning in a dense cloud wireless network according to an embodiment of the present disclosure;

FIG. 5A is a diagram illustrating an example of generation of an expected area according to an embodiment of the present disclosure;

FIG. 5B is a diagram illustrating an example of generation of an overlapping area according to an embodiment of the present disclosure;

FIG. 6 is a diagram illustrating an example of a network layout according to an embodiment of the present disclosure;

FIG. 7 is a diagram illustrating a coverage performance graph of a reinforcement learning model for a handover number according to an embodiment of the present disclosure;

FIG. 8 is a diagram illustrating a coverage performance graph of a reinforcement learning model for an average reward according to an embodiment of the present disclosure;

FIG. 9 is a diagram illustrating a handover number-of-times performance graph for the number of RRHs according to an embodiment of the present disclosure;

FIG. 10 is a diagram illustrating a relevant period performance graph of an average user terminal and RRH for the number of RRHs according to an embodiment of the present disclosure;

FIG. 11 is a diagram illustrating a handover number-of-times performance graph for the number of user terminals according to an embodiment of the present disclosure;

FIG. 12 is a diagram illustrating a relevant period performance graph of an average user terminal and RRH for the number of user terminals according to an embodiment of the present disclosure;

FIG. 13 is a diagram illustrating a handover number-of-times performance graph for a movement velocity of a user terminal according to an embodiment of the present disclosure;

FIG. 14 is a diagram illustrating a relevant period performance graph of an average user terminal and RRH for a movement velocity of a user terminal according to an embodiment of the present disclosure;

FIG. 15 is a diagram illustrating a method for user association based on fuzzy logic and accelerated reinforcement learning in a dense cloud wireless network according to an embodiment of the present disclosure; and

FIG. 16 is a diagram illustrating a functional configuration of an apparatus for user association based on fuzzy logic and accelerated reinforcement learning in a dense cloud wireless network according to an embodiment of the present disclosure.

### DETAILED DESCRIPTION OF THE PREFERRED EMBODIMENT

The present disclosure may have various modifications and various embodiments and specific embodiments will be illustrated in the drawings and described in detail.

Various features of the present disclosure disclosed in claims will be able to be more well appreciated by considering drawings and Detailed Description. An apparatus, a method, a preparation, and various embodiments disclosed in the specification are provided for an illustrative purpose. Features on a structure and a function disclosed are used to allow those skilled in the art to specifically carryout various embodiments, and not used to limit the scope of the present disclosure. Disclosed terms and sentences are used for describing various features of the present disclosure disclosed to be easily appreciated, and do not limit the scope of the present disclosure.

In describing the present disclosure, a detailed description of related known technologies will be omitted if it is determined that they unnecessarily make the gist of the present disclosure unclear.

Hereinafter, a method and an apparatus for user association based on fuzzy logic and accelerated reinforcement learning in a dense cloud wireless network according to an embodiment of the present disclosure will be described.

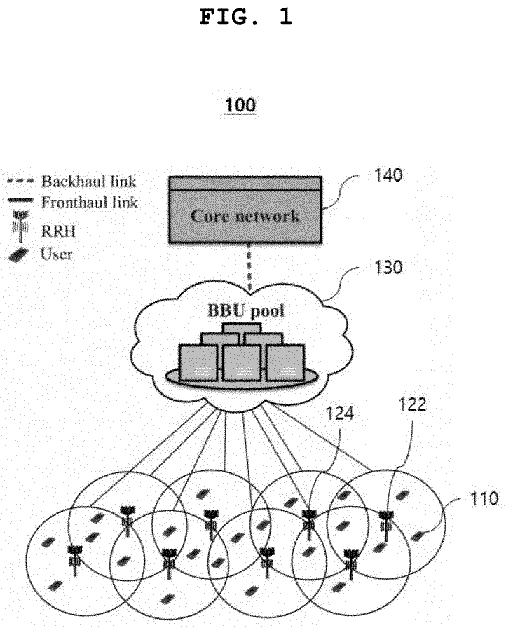

FIG. 1 is a diagram illustrating a system 100 for user association based on fuzzy logic and accelerated reinforcement learning in a dense cloud wireless network according to an embodiment of the present disclosure.

Referring to FIG. 1, the user association system 100 may include a user terminal 110, a serving remote radio head (RRH) 122, a target RRH 124, a base band unit (BBU) controller 130, and a core network server 140.

In this case, each RRH may be connected to the BBU controller 130 through a fronthaul link, and the BBU controller 130 and the core network server 140 may be connected through a backhaul link.

In an embodiment, in the C-RAN, a base station may include the BBU controller 130 and the RRHs 122 and 124. The BBU controllers of various sites may be centralized and virtualized by using cloud computing and virtualization technologies.

An centralized and virtualized architecture of the C-RAN may provide advantages of being adapted to dynamic traffic fluctuation, and achieving load distribution, cost saving, and interference minimization.

In the C-RAN, the RRHs 122 and 124 are connected to the BBU controller 130 through the fronthaul link. Here, the BBU controller 130 may be referred to as ‘BBU pool’ or a terminology having an equivalent technical meaning thereto.

Further, interference between the RRHs may be relaxed by joint adjustment through centralized cooperation processing in the BBU controller 130.

However, due to a limited fronthaul capacity, the number of user terminals 110 which one serving RRH 122 may support at a specific time may be limited.

In an embodiment, the RRHs of the C-RAN are layered and arranged densely, so the user terminals 110 may move at different velocities.

As a result, when the user terminal 110 moves from coverage of one RRH to coverage of the other RRH within a short time, frequent handover may occur.

At a specific position, the user terminal 110 may be in a range of two or more RRHs 122 and 124. Further, the user terminal 110 may receive a high signal from multiple RRHs.

It may be necessary to effectively execute the handover so that the connection with the serving RRH 122 is not frequently changed. The user terminal 110 may be connected to an RRH of which connection is maintained longer during the handover.

Further, parameter selection for a handover trigger condition may be optimized. Further, a parameter may be used for reducing a handover number while maintaining the connection at a minimum data velocity.

Due to mobility of the user terminal 110, the connection may be broken in a next timestamp even though a current received signal is strong.

Therefore, the parameter may be selected so as to approximate an available position at a next time.

Further, the target RRH 124 of multiple candidate RRHs for association with the user terminal may be selected upon the handover.

Further, the RRH selected to reduce the total number of handover times may be performed to maintain the connection during a longer period instead of performing the RRH selection for the connection of the user terminal 110.

According to the present disclosure, the number of frequent handover times may be minimized while examining a user recombination problem and maintaining a QoS requirement of the user terminal 110 in the C-RAN.

In a proposed technique, the handover trigger condition is determined and a handover control parameter called time-to-trigger (TTT) is optimized.

Here, the TTT may represent a duration for which the connection between the user terminal 110 and the serving RRH 122 is maintained after a received signal strength of a signal which the user terminal 110 receives from the serving RRH 122 is less than a threshold.

The BBU controller 130 may consider the movement velocity of the user terminal 110 and a distance between the user terminal 110 and the serving RRH 122 jointly with the received signal strength of the user terminal 110 in order to start the handover.

Further, the TTT may be optimized by using the parameter jointly with a fuzzy logic function.

Further, when a handover event starts according to determination of the fuzzy logic function, the BBU controller 130 may select the target RRH 124 for the user terminal 110.

Further, the BBU controller 130 may select the target RRH 124 so as to maintain the connection longer by using a reinforce learning (RL) model. Here, the RL model may be referred to as ‘RL algorithm’ or a terminology having an equivalent technical meaning thereto.

Further, the BBU controller 130 may allow the RL model to be converged more quickly by performing prediction based virtual reward generation and mapping of virtual reward and actual reward. This may be to optimize both handover triggering and target RRH selection during the handover for the reconnection.

Further, the BBU controller 130 may increase a learning velocity of the RL algorithm for user association by utilizing a prediction based virtual reward update. The acceleration technique may promote faster convergence by enhanced performance.

In an embodiment, the handover trigger condition may be optimized by adjusting the TTT value by using a fuzzy logic by considering the received signal strength, the distance between the user terminal 110 and the serving RRH 122, and the movement velocity of the user terminal 110.

Therefore, early handover may not occur in the network while maintaining the connection.

In an embodiment, the BBU controller 130 may select the target RRH 124 for the user terminal 110 by using the RL model after the handover trigger condition is satisfied. This is to maintain the connection of the target RRH 124 long as possible.

In an embodiment, a state space for the RL model may be configured based on user terminal 110 and RRH information, and used for selecting the target RRH 124 for association, and a reward function may reflect a purpose of an action.

In an embodiment, the BBU controller 130 may generate the prediction based virtual reward jointly with the actual reward under a specific condition in order to accelerate the fusion of the RL model.

In an embodiment, the user association system 100 may include m mmWave small RRHs arranged densely in the network. For example, the user association system 100 may include a C-RAN architecture.

The RRH is distributed by an overlapping scheme to minimize a non-service area while increasing a total network capacity.

An RRH set may be represented by M. Here, M may be represented as M=1, 2, . . . , m.

Further, the network may include n user terminals 110 which freely move at a predetermined probability. Here, a user terminal set is N and N may be represented as N=1, 2, . . . , N.

All RRHs may be connected to the BBU controller 130 through the fronthaul link. The BBU controller 130 may control information received from the user terminal 110 and the connection between the user terminal 110 and the RRH each time. In this case, as a time slot t which may be represented by [symbol] =1, 2, . . . , T, an evenly divided time period may be considered. The position of each user terminal 110 may be changed for each time zone.

Positional coordinates of the user terminal 110 may be represented by (xᵢ, yᵢ) for i∈N. Further, the position of the RRH may be represented by (xⱼ, yⱼ) for j∈M.

In an embodiment, several assumptions may be made for the C-RAN and the user terminal 110.

For the RRHs 122 and 124, it is assumed that transmission ranges of all mmWave small RRHs are the same as each other, and a coverage area may be represented by a circle having a radius R.

A directional antenna required for providing beamforming to an mmWave system is mounted on the mmWave RRH.

However, the number of user terminals 110 which the RRH may support at a specific time is limited according to a capacity of the RRH.

In respect to the BBU controller 130, the BBU controller 130 may obtain network information. The network information may be periodically updated based on a user report obtained through the connected RRH.

The positional coordinates and the coverage areas of all RRHs may also be known to the BBU controller 130. The BBU controller 130 may execute an algorithm for performing the handover and association determination, and then transmit the algorithm to a subsequent RRH.

In respect to the connection of the user terminal 110, each user terminal 110 may have a single antenna device. That is, one user terminal 110 may be connected only to one serving RRH 122 of the network at a specific time t.

The user terminal 110 may move in the network by using a modified random walk mobility model.

It is assumed that the user terminal 110 has a positional service (e.g., GPS), and when a specific condition is satisfied, the user terminal may transmit positional information to the serving RRH 122.

In respect to a radio wave model, it may be assumed that a channel of the mmWave RRH is based on a 3GPP standard LOS model. The LOS model may determine a visible-ray mmWave link which is present between the user terminal and the RRH.

Further, an NLOS connection may not be considered in a high-density mmWave network in which the RRHs are overlapped.

In an embodiment, a pathloss model may be shown as in <Equation 1>.

PL(D)=α+10β log₁₀(D_{i,j}+x, x˜N(0,σ²) [Equation 1]

Here, D_{i,j} represents a distance between user terminal i and RRH j, and α and β represent floating intercept for a measured distance and a least square fit of a slope, respectively. o² represents a log-normal shadowing variance. In an embodiment, D_{i,j} may be shown as in <Equation 2>.

D_{i,j}=\sqrt{(xᵢ−xⱼ)²+(yᵢ−yⱼ)²} [Equation 2]

In an embodiment, inter-user terminal interference may be disregarded due to beamforming of an mmWave band. Therefore, a signal to noise ratio (SNR) of a signal which user terminal i receives from RRH j may be shown as in <Equation 3>.

$${δ}_{i , j} = \frac{{P}_{j} \times Ω \times {PL ( D )}^{- 1}}{{P}_{n}} \qquad [ Equation 3 ]$$

Here, Pⱼ represents transmission power of RRH j, Pₙ represents noise power, and Ω represents an antenna gain.

In an embodiment, the directional antenna may be mounted on RRH j, and a non-directional antenna may be mounted on user terminal i. Therefore, Ω may represent a function of an angle of departure, θ up to the user terminal from the RRH, and may be shown as in <Equation 4>.

$$Ω ( θ ) = \text{?} \qquad [ Equation 4 ]$$

$$\text{?} \text{indicates text missing or illegible when filed}$$

Here, Ωₘₐₓ represents an antenna gain of a main lobe, Ωₘᵢₙ represents an antenna gain of a side lobe, and θ_{b} represents a width of an antenna main lobe.

Further, beam tracking may be perfectly used to maintain the mmWave connection between user terminal i and RRH j. Therefore, user terminal i may obtain a high antenna gain in the main lobe.

The number of user terminals i which RRH j may service at once may be equal to the number of beams which may be generated by the RRH.

RRH j may generate maximum beams [symbol] during a single time period, and this may mean that a service may be simultaneously provided to [symbol] user terminals.

All user terminals related to RRH j may be evenly allocated with a bandwidth resource. Therefore, a throughput achieved by user terminal i connected to RRH j according to the Shannon capacity formula may be shown as in <Equation 5>.

$$\text{?} \qquad [ Equation 5 ]$$

$$\text{?} \text{indicates text missing or illegible when filed}$$

Here, BWⱼ represents the bandwidth of RRH j and Uⱼ represents the number of user terminal serviced by RRH j.

First, all user terminals may be connected to the RRH based on the received SNR. The user terminal may be connected to an RRH obtaining a highest SNR.

An association indicator between user terminal i and RRH j, σ_{i,j} may indicate whether user terminal i and RRH j are associated with each other, and may be shown as in <Equation 6>.

$$\text{?} \qquad [ Equation 6 ]$$

$$\text{?} \text{indicates text missing or illegible when filed}$$

In an embodiment, in respect to a QOS model, the QoS requirement of the user terminal 110 with the serving RRH 122 may be maintained by using two metrics an SNR threshold δₜₕ and time-to-trigger (TTT) Δ_{T}.

δₜₕ may represent a minimum SNR, and Δ_{T} may represent a period during which the user terminal maintains the connection while obtaining an SNR of a threshold or less.

The user terminal 110 may wait until 0 becomes Δ_{T} before sending a measurement report to the serving RRH 122.

The QoS requirement of user terminal i may be met when the condition of <Equation 7> is satisfied.

∃t∈[T_{c},T_{c′}−Δ_{T}], s.t. δ_{i,j}(t)>δₜₕ; ∀_{T}_{_{c}}_{,T}_{_{c′}}∈ [symbol] [Equation 7]

Here, T_{c} and T_{c′} represent each handover time at two continuous times, and t represents a time when the user terminal 110 obtains an SNR larger than the threshold, and shows a QoS satisfaction of the user terminal 110.

In respect to the handover trigger condition, the SNR value of the serving RRH 122 is smaller than the threshold SNR value. In an embodiment, for convenience of description, the SNR value is used as an example of a signal strength, but the present disclosure is not limited thereto, and various signal strength values may be used.

The trigger condition may be shown as in <Equation 8>.

Serving RRH SNR<threshold SNR−HOM [Equation 8]

Here, HOM represents a handover margin added to in order to reduce ping pong handover. Therefore, this value may be set to 0 for simplification.

A conventional handover event occurs when the condition of Equation 8 satisfies a predefined time called TTT.

When the handover event is triggered, the user terminal 110 may monitor the SNR received from the serving RRH 122.

When the SNR does not exceed the threshold SNR during the TTT time, the user terminal 110 may transmit the measurement report to the serving RRH 122.

A frequency of the measurement report transmitted by the user terminal 110 may be set by a network operator.

According to the present disclosure, the TTT value which is a handover control parameter may be adjusted to minimize early handover and late handover. In this case, when the TTT value is high, the handover may be too late and when the TTT value is low, the handover may be faster.

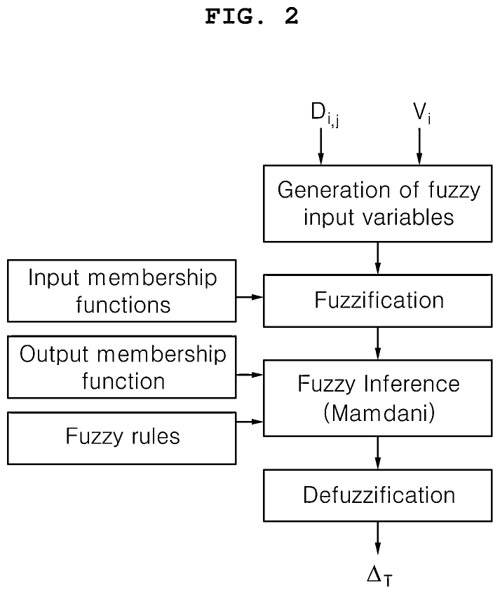

FIG. 2 is a diagram illustrating a fuzzy logic function based TTT value optimization process according to an embodiment of the present disclosure.

Referring to FIG. 2, the BBU controller 130 may adjust the TTT so that the connection is continued without a wireless link failure. According to the present disclosure, the BBU controller 130 may apply the fuzzy logic function to the operation in order to adjust the TTT value. Therefore, the user terminal 110 may maintain the connection with a current service RRH during the optimized TTT time.

In an embodiment, in order to optimize the TTT value using the fuzzy logic function, the fuzzy logic function may represent an inference method that maps a control input set to a control output set through a fuzzy rule.

A fuzzy logic process may be constituted by three stages: making all input values be fuzzy with a membership function, fuzzy inference based on a rule set, making reverse fuzzy of an output function. A fuzzy input is connected to a language variable.

A rule may be generated by using the language variable for each input. An inference engine may select a best rule for updating an output parameter. An output may determine a conclusion for each rule.

The BBU controller 130 may adjust the TTT value when the SNR which the user terminal receives from the serving RRH is less than the threshold SNR δₜₕ through the fuzzy logic function.

It is considered that the handover is performed based on the received SNR in the conventional most handover schemes, but unnecessary and frequent handover may be performed in a small RRH based C-RAN scenario. Further, the RRH may be arranged so that application ranges of some RRHs are overlapped. Therefore, the user terminal 110 may simultaneously obtain the SNR in multiple RRHs. This may cause the ping pong handover when the user terminal 110 is associated with the RRH which is based on only the SNR. Further, the user terminal 110 may return to a previous RRH when a serving SNR is lowered in a next period.

Therefore, according to the present disclosure, the BBU controller 130 may determine a period within the application range of the RRH providing the service by considering the distance between the user terminal and the serving RRH and the movement velocity of the user terminal.

It is possible to make fuzzy two inputs, i.e., a movement velocity vi of the user terminal and a distance D_{i,j} between the user terminal and the serving RRH.

Three language variables may be allocated to each fuzzy input by using a triangular membership function.

A triangular membership function may be defined by a lower limit a, an upper limit b, and an m value. Here, a<m<b may be established. Each element of an input x may be mapped to a value between 0 and 1.

Therefore, the triangular membership function may be shown as in <Equation 9>.

$$μ ( x ) = \{ \begin{matrix}0 , x \leq a , \\ \frac{x - a}{m - a} , a < x \leq m , \\ \frac{b - x}{b - m} , m < x < b , \\ 0 , x \geq b .\end{matrix} \qquad [ Equation 9 ]$$

A fuzzy rule set may include all relationships available between two input values and one output value.

Since two language variables are present in each input, a total of 9 rules may be generated by all combinations of input variables.

Since the number of language variables determines the number of fuzzy rules, the number of language variables may be set to 3.

While a large number of fuzzy rules lead to more memory requirements and calculation time, a small number of fuzzy rules may lead to inaccurate inference. In this case, as illustrated in FIG. 2, an output of a fuzzy process may be represented by Δ_{T}.

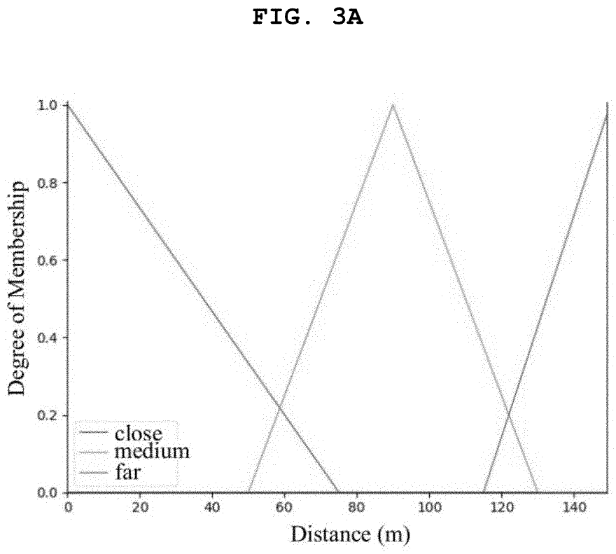

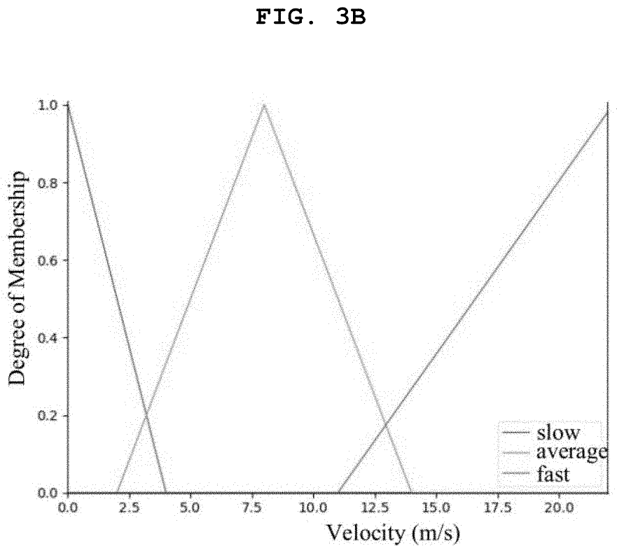

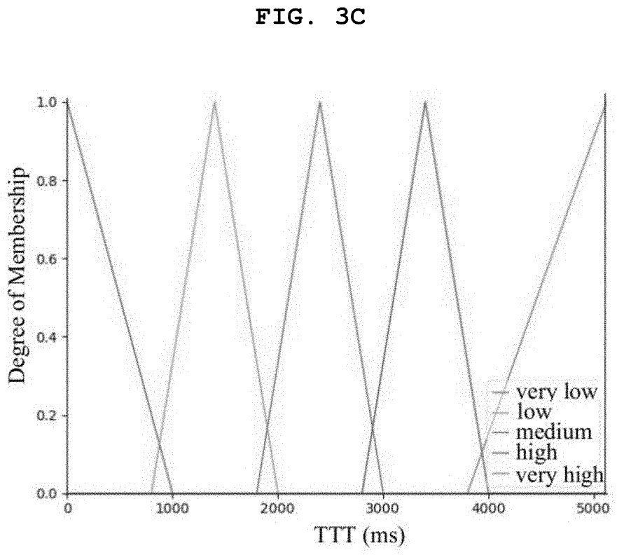

FIG. 3A is a diagram illustrating an affiliated function graph for a distance input between a user terminal and serving RRH according to an embodiment of the present disclosure. FIG. 3B is a diagram illustrating an affiliated function graph for a movement velocity input of a user terminal according to an embodiment of the present disclosure. FIG. 3C is a diagram illustrating an affiliated function graph for a TTT value according to an embodiment of the present disclosure.

Referring to FIGS. 3A to 3C, a linguistic variable of an input having a degree of the corresponding membership function may be shown as expressed in <Equation 9>.

The velocity vᵢ may be divided into slow, normal, and fast, and the distance D_{i,j} may be divided into proximal, medium, and long distance.

A core width and a boundary region of the membership function may be selected by using a trial and error approach.

Since intersections are a lot, various rules may be frequently activated, an intersecting area of an adjacent linguistic variable may be appropriately selected.

As overlapping is not made, flexibility and smoothness may be weakened.

A Mamdani type inference method may be used for mapping the input to the output of the fuzzy system which is the TTT value.

In the case of the TTT value, the triangular membership function set may be used to achieve reasonable segmentation in the output: very low, low, medium, high, and very high.

In an embodiment, a fuzzy logic based TTT optimization procedure may be shown as in <Table 1>.

TABLE 1
Algorithm 1 TTT optimization with fuzzy logic

| | |
|---|---|
| 1: | Initialize SNR threshold δₜₕ, fuzzy rules, and Δ_{T} = 0 |
| 2: | for time t = 1, 2, . . . T ∈ [symbol] do |
| 3: | for user i connected to RRH j, ∀i do |
| 4: | if δ_{i,j} ≤ δₜₕ and Δ_{T} = 0 then |
| 5: | Check vᵢ and D_{i,j} |
| 6: | Update Δ_{T} with fuzzy inference |
| 7: | else if Δ_{T} > 0 then |
| 8: | Δ_{T} = Δ_{T} − 1 |
| 9: | if Δ_{T} = 0 and δ_{i,j} ≤ δₜₕ then |
| 10: | Handover events occurs |
| 11: | end if |
| 12: | if δ_{i,j} > δₜₕ then |
| 13: | Δ_{T} = 0 |
| 14: | end if |
| 15: | end if |
| 16: | User moves with vᵢ |
| 17: | end for |
| 18: | end for |

In this case, initially, Δ_{T} may be set to 0 and the movement of the user terminal may start.

When the user terminal i satisfies the handover trigger condition, received SNR δ_{i,j} of the user terminal i from the RRH j is equal to or less than a predefined threshold SNR value δₜₕ, and the fuzzy rule process may be activated.

The TTT value may be updated by using the fuzzy rule. The TTT may be continuously reduced until the TTT becomes 0, and the user terminal 110 may continuously move in the network by the same connection.

When a received SNR condition is maintained after the TTT ends, the handover event may be initialized.

When the received SNR is larger than the threshold during the TTT, the user terminal 110 may not consider the handover.

In candidate RRH selection, the BBU controller 130 may select the target RRH 124 suitable for the user terminal 110 after the TTT ends.

In the case of the user terminal i which sends the measurement report to the BBU controller 130, the BBU controller 130 may select a candidate RRH based on the SNR value which the user terminal 110 receives from the adjacent RRH. Further, the BBU controller 130 may select the target RRH 124 among the RRHs selected as the candidate RRH.

In an embodiment, Aₖ represents a set of RRHs available when the handover event occurs for the user terminal i at the time t, and may be shown as in <Equation 10>.

Aₖ(t)={k|δ_{i,j}(t)>δₜₕ, ∀ₖ∈Aₖ, Aₖ⊆M} [Equation 10]

Here, k represents an index of the candidate RRH.

Therefore, the BBU controller 130 may connect the RRH and the user terminal i of the set Aₖ in which the user terminal-RRH connection is maintained longer.

In an embodiment, when the user terminal 110 sends the measurement report to the serving RRH 124 at the end of the TTT, the BBU controller 130 may select the appropriate target RRH 124 for the user terminal 110 based on the RL model to be described below. Here, the RL model may be referred to as ‘RL algorithm’ or a terminology having an equivalent technical meaning thereto.

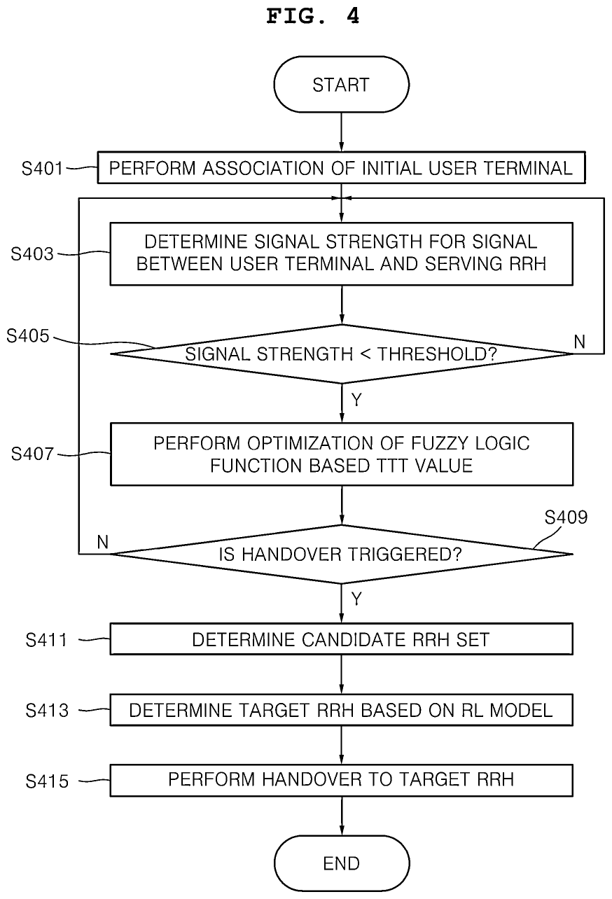

FIG. 4 is a diagram illustrating a method for user association based on fuzzy logic and accelerated reinforcement learning in a dense cloud wireless network according to an embodiment of the present disclosure. In an embodiment, each step of FIG. 4 may be performed by the BBU controller 130.

Referring to FIG. 4, step S401 is a step of performing initial association between the user terminal 110 and the serving RRH 122. That is, the user association may be performed with the user terminal 110.

Step S403 is a step of determining a signal strength for a signal between the user terminal 110 and the serving RRH 122.

Step S405 is a step of determining whether the signal strength is smaller than a threshold. In an embodiment, when the signal strength is not smaller than the threshold, the process may proceed to step S403.

Step S407 is a step of adjusting a fuzzy logic function based TTT value when the signal strength is smaller than the threshold.

Step S409 is a step of determining whether to trigger the handover according to the adjusted TTT value. In an embodiment, when it is determined that the trigger of the handover is not performed, the process may proceed to step S403.

Step S411 is a step of determining a candidate RRH set when it is determined that the trigger of the handover is performed. Here, the candidate RRH set may include multiple candidate RRHs.

Step S413 is a step of determining the target RRH among multiple candidate RRHs based on the RL model.

Step S415 is a step of performing the handover to the target RRH.

In other words, in an embodiment, in respect to selection of the RL model based target RRH 124, the RL model may include an agent for learning which interacts with an environment.

The agent may take an action aₜ∈A at each determination time t∈T by observing a state sₜ∈S. Then, the agent may move to a next state sₜ₊₁∈S and receive a reward rₜ as a feedback mechanism.

The reward may represent a purpose of a problem and a goal of the agent may be to maximize an entire reward.

A policy π(s): [symbol] → [symbol] may be defined, which maps the state to the action.

The goal of the agent may be to learn an optimal policy π* for maximizing an accumulation reward.

Most RL models such as Q-learning may regard the reward of each repetition as a discounted reward which is based on next continuous steps.

Since a future reward does not influence a current action during each handover event, this may be limited.

In the RL model, all states may be independent from each other, and a received reward may be related only to an executed action. Therefore, the agent may often learn an action that provides a best reward.

Contextual bandits is a sub set of a significantly simple RL model. Only one step before a result is observed may be present.

The contextual bandits may be an extension of a multiarmed bandit approach scheme in which context or state information is considered.

Unlike a multiarmed bandit, since the state influences a scheme associated with each action, the state is changed, so the model should be able to learn a method for adjusting action selection.

In an embodiment, the reward may vary depending on an environmental state, and the reward may vary for the same action which is taken in another state.

The RL model may observe a context (state), and perform an action in multiple available actions and observe a result (reward) of the corresponding action.

In the RL model, a candidate RRH k∈Ak(t) at each determination time t may be an action available in a specific state.

When the handover event is triggered according to <Table 1>, the agent of a centralized BBU controller 130 may observe a state including association information between the user terminal 110 and the RRH, and select the target RRH 124 through exploration or exploitation and receive an immediate reward.

Therefore, it is possible to connect the RRH and the user terminal 110 capable of maintaining the connection for a longer time again while the user terminal 110 satisfies the QoS requirement of the user terminal 110.

The RL model may learn the association of the user terminal 110 and the RRH based on a velocity, a direction, a movement angle, and a distance from the associated RRH of the user terminal 110.

In an embodiment, in respect to a state construction, when the handover event is triggered, the agent may identify may identify the serving RRH 122 and an association feature of the serving RRH 122. Here, the association feature of the serving RRH 122 may construct the state of the agent.

In an embodiment, a state space S may include four elements: an index of the serving RRH 122, a distance between the user terminal 110 and the RRH, an angle between the user terminal 110 and the RRH, and a direction of the user terminal facing the RRH.

In a specific state sₜ of the time t, the agent may learn user terminal-RRH association information in the triggered handover event.

Therefore, the element of the state may be represented by {j,D_{i,j},Θ_{i,j}, [symbol] _{i,j}}.

Here, j represents a serving RRH index, D_{i,j} represents a distance between user terminal i and RRH j, Θ_{i,j} represents an angle between user terminal i and RRH j, [symbol] _{i,j} and represents a movement direction of user terminal i facing RRH j.

When the association features are combined, the association feature x_{i,j}=(D_{i,j}, Θ_{i,j}, [symbol] _{i,j}) may be represented for predetermined user terminal i and RRH j.

Here, x represents the association feature of user terminal i and RRH j. x_{i,j}∈X_{i,j} represents an xₜₕ association feature in all feature sets.

x_{i,j}∈X_{i,j} represents a state related to RRH j∈M for all handover events the user terminal i requests at the time t expressed as s_{j,x}_{_{i,j}}^{t}. The state of the time t is represented by sₜ for simplification.

In an embodiment, the element of the association feature in the state may be a continuous value. When all values for the parameter are taken, the state space may be infinite and the agent may not reach convergence.

The RL model may require a discrete state space to operate in the environment.

Therefore, it is necessary to obtain a discrete value for the element of the state space.

The distance D_{i,j} between the user terminal 110 and the RRH may be divided into f chunks so that D_{i,j}∈1, 2, 3, 4, 5 is established. As the value is smaller, the distance between the user terminal 110 and the RRH may decrease.

D_{i,j}=1 may mean that the user terminal 110 is within a distance closest to the RRH, and D_{i,j}=5 may mean that the user terminal 110 is within a distance farthest from the RRH.

A value of each Θ_{i,j} in the association feature of the user terminal 110 and the RRH may be divided into 8 categories and given as Θ_{i,j}∈1, 2, 3, 4, 5, 6, 7, 8. Here, −180°≤Θ_{i,j}≤180° may be established.

A direction [symbol] _{i,j} of i facing j may be divided into two groups in an internal direction and an external direction. [symbol] _{i,j} may be calculated from a difference between the distance at the time t and the distance at the time t−1. The distance between the user terminal i and the RRH j at the time t may be expressed as D_{i,j}^{t}. Further, the distance at the time t−1 may be D_{i,j}^{t-1}.

When D_{i,j}^{t}>D_{i,j}^{t-1}, D_{i,j}^{t}>D_{i,j}^{t-1} may mean that the distance between the user terminal 110 and the RRH increases. In this case, the user terminal 110 may move outward from the RRH.

Similarly, D_{i,j}^{t}>D_{i,j}^{t-1} represents that the user terminal 110 moves in the internal direction from the RRH because a distance at a current time is smaller than a distance at a previous time.

D_{i,j}^{t}=D_{i,j}^{t-1} may mean that there is no motion of the user terminal or no change in RRH direction.

In respect to the action, the agent of the BBU controller 130 may select the target RRH 124 in the candidate RRH set Ak.

As in at∈Ak(t) which is the selected target RRH, the corresponding action may represent an action aₜ at the time t.

The number of actions available in the state sₜ at the time t may indicate the number of available RRHs k.

In respect to the reward, the reward function of the agent of the BBU controller 13 may be determined to motivate the agent to take an action that maximizes the accumulation reward.

Since the target RRH 124 for the user terminal 110 which is to maintain the association for a longest period is selected, the reward may be determined for the selection.

Therefore, the reward function rₜ in the state sₜ may be shown in order to take the action aₜ at the time t as in <Equation 11>.

rₜ=T_{c}′−T_{c}, ∀_{t,T}_{_{c}}_{′,T}_{_{c}}∈ [symbol] [Equation 11]

Here, T_{c} means a time when the handover occurs, and the user terminal 110 is connected to the target RRH 124 selected by the action aₜ, and T_{c}′ represents a next handover time. Here, t represents a repetition counter time as seconds. T_{c} and T_{c}′ represent start and end counters of the handover, respectively.

In an embodiment, time units may be the same, but here, the time units are represented by T_{c} and T_{c}′ in order to represent a connection time for convenience.

Therefore, the reward may include a period in which the connection between the user terminal and the RRH is maintained. Since maximizing the reward is that a connection duration is also maximized, a total number of handover times may be minimized.

Since this may not be calculated until the next handover occurs, rt may not be obtained immediately after taking a measure.

In respect to an exploration-exploitation strategy, when the handover event occurs, the agent of the BBU controller 130 may select one target RRH 124 in the candidate RRH set Aₖ and reduce the total number of handover times.

An exploration-exploitation trade-off may be a key task of the RL model when selecting a best action without being imprisoned for local optimization. In order to solve this problem, a [symbol] -greedy policy may be used.

The agent may select a predetermined action in the available action set with a probability in the [symbol] -greedy policy. This step may be referred to as exploration.

Otherwise, the agent may select an action that maximizes the reward in an exploitation step.

When the handover event occurs at the time t, a policy k* may be to select the target RRH 124 in the candidate RRH set Aₖ(t) satisfying <Equation 12>.

$${k}^{*} = arg {max}_{k} {\sum }_{t ∈ τ} {r}_{t} ( k ) \qquad [ Equation 12 ]$$

In an embodiment, <Table 2> may show an entire RL based RRH selection procedure.

TABLE 2
Algorithm 2 RL-based RRH selection algorithm

```
  1: Initialize ϵ, total simulation time [symbol]
  2: while Handover event occurs according to Algorithm 1
  do
  3:  Record the current time T_{c} ∈ [symbol]
  4:  Observe the state sₜ
  5:  Check the available actions k, k ∈ [symbol] ₖ, [symbol] ₖ ⊆ M
  6:  if Rand(0,1) < ϵ then // Exploration
  7:  Select a random action aₜ ∈ [symbol] ₖ
  8:  Observe the reward rₜ according to Eqaution II
        when the next handover occurs at T_{c}′ ∈ [symbol]
  9:  else // Exploration
10:  if sₜ ∉ [symbol]  then
11:  Calculate the virtual reward r_{t,v}^{k}, ∀ₖ ∈ [symbol] ₖ
12:  Select action aₜ = argmaxₖ r_{t,v}^{k}
13:  else if Some actions ϵ ∈ [symbol] ₖ are explored then
14:  Calculate the virtual reward r_{t,v}^{k}, ∀ₖ ∈ [symbol] ₖ
15:  Calculate bias $b = \frac{r \text{?}}{r \text{?}} ,$
          ∀e ∈ Aₖ
16:  Calculate the new reward r [symbol]  = b [symbol]  r [symbol]
          ∀e′ ∈ A_{e′} where A_{e′} = Aₖ\{e}, ∀e
17:  Select action aₜ = argmax_{e,e′} (r [symbol]  ∪ r [symbol] ),
          ∀e, e′ ∈ Aₖ
18:  else
19:  Select action aₜ = argmaxₐ_{ₜ} (rₜ)
20:  end if
21:  end if
22: end while [symbol]
indicates data missing or illegible when filed
```

<Table 2> may be called when the handover event is triggered after the end of the TTT. As described above, the current time may be recorded as T_{c}.

The agent may observe the state sₜ and confirm all RRHs available for reconnection in the candidate RRH set Aₖ.

[symbol] In the case of the [symbol] -greedy policy, the exploration or exploitation may be determined by using a random variable.

In the exploitation step, the virtual reward may be calculated to selecting the best action in two cases.

When the agent is in a state in which the action is not explored previously as in sₜ∉ [symbol] or the agent is in a state in which only some actions e∈Aₖ are explored, the virtual reward may be calculated.

This reward may be calculated for all actions k available in the state sₜ based on a future location prediction mechanism. The mechanism may be used for faster convergence of the RL model, and may be referred to as an acceleration technique in the present disclosure.

When a first condition is satisfied so that the state sₜ becomes a new state, the agent may perform an action in which a maximum virtual reward is defined as r^{k}_{t,v}.

In a second case, the agent may similarly calculate the virtual reward for all available actions.

Then, a bias value b may be calculated by using the actual reward and the virtual reward for the action e∈Aₖ explored in the state sₜ.

Thereafter, a new reward [symbol] may be calculated for an action ∀e′∈ [symbol] _{e′} which is not exploited by multiplying all explored actions by a virtual reward value and the bias value. Here, A_{e′}= [symbol] ₖ\{e} represents a set of actions which are not explored in a specific state.

The agent may select an action having a highest reward for all exploration and non-exploration actions. Here, the reward may mean both an actual reward rₜ^{e} and a new calculated reward [symbol] for the explored action.

Last, when all actions available in sₜ are explored previously, the agent may select an action having a maximum reward.

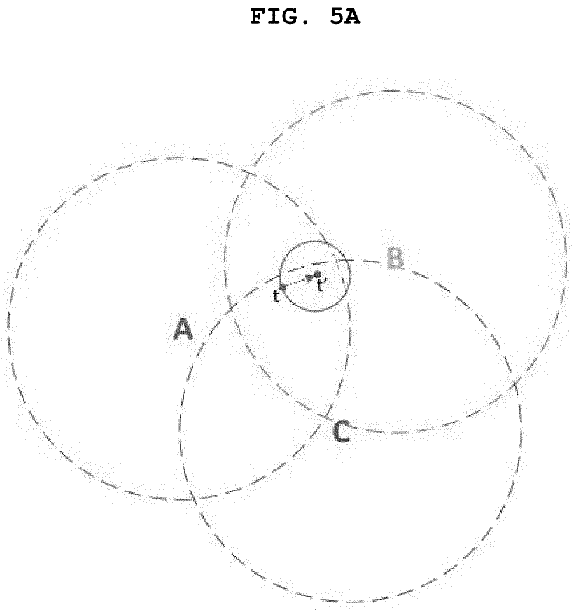

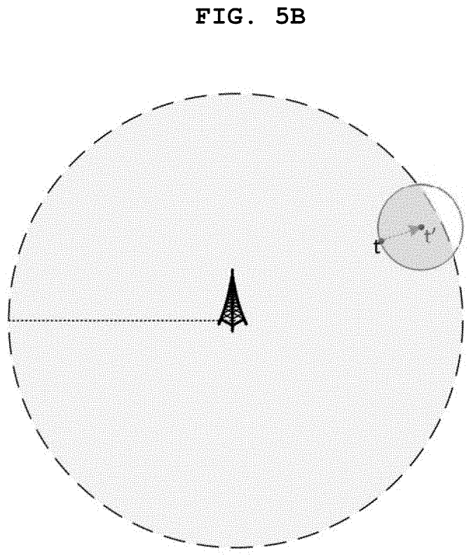

FIG. 5A is a diagram illustrating an example of generation of an expected area according to an embodiment of the present disclosure. FIG. 5B is a diagram illustrating an example of generation of an overlapping area according to an embodiment of the present disclosure.

Referring to FIGS. 5A and 5B, in respect to an acceleration technique, a prediction method may be used, which uses language-based extrapolation by using a past trajectory of the user terminal 110 in order to calculate the virtual reward.

Then, an overlapping area with the RRH may be generated by exploiting an approximate future location of the user terminal 110. Here, the future location of the user terminal 110 may be referred to as BBU controller 110 may be referred to as an ‘expected location’ or a terminology having an equivalent technical meaning thereto.

A future overlapping region may reflect a period in which the user terminal 110 may stay in an application range of a specific RRH.

Therefore, the agent may update the virtual reward for the corresponding state-action pair based on an overlapping area value, and the proximity and the direction.

In an embodiment, in respect to future location prediction, a Lagrange polynomial expression may be used for generating an approximate value for a predetermined function. The location may be calculated in a 2D space for the time.

In several continuous time stamps, an extrapolation of a Lagrange method for the future location of the next time stamp may be exploited by using past location coordinates of the user terminal 110.

The Lagrange method may generate a polynomial expression for describing a movement path of the user terminal 110 by using the coordinates.

At the time t, the location of the user terminal i for the time may be expressed as (X_{i,t}, Y_{i,t}) The location coordinates of the user terminal 110 for an n+1 data point for a degree n may be determined. Here, n may be represented as n=1, 2, . . . , t−1.

X-axis and Y-axis values for the time may be separately generated, and the future location of the user terminal 110 may be determined through an exploration value.

At a time t′ for a degree n with an X-axis value X_{i,t′} and a Y-axis value Y_{i,t′}, the future location of the user terminal i may be expressed as in <Equation 13> and <Equation 14>.

$$\text{?} \qquad [ Equation 13 ]$$

$$\text{?} \qquad [ Equation 14 ]$$

$$\text{?} \text{indicates text missing or illegible when filed}$$

Here, p and q represent data point values of the continuous timestamps. t′ represents an approximate time for the future location of the user terminal 110.

The future location of the user terminal i for the next timestamp t′ may be expressed as (X_{i,t′},Y_{i,t′}).

In an embodiment, in respect to overlapping region creation, an expected area may be generated based on the movement velocity of the user terminal 110 at a predicted location (X_{i,t′},Y_{i,t′}).

The expected area may show a circle Cₑ including all available locations where the user terminal 110 may be present in several continuous future timestamps.

The expected area circle Cₑ may be generated for the user terminal i centering on the future location (X_{i,t′},Y_{i,t′}) with a radius ρ, and this may be shown as in <Equation 15> by using a predicted displacement of the user terminal 110 given as follows.

ρ=\sqrt{(X_{i,t′}−X_{i,t})²+(Y_{i,t′}−Y_{i,t})²} [Equation 15]

Here, t′ represents the future timestamp when the location is approximated and t represents the current time stamp.

The BBU controller 130 may calculate the overlapping area between the expected area circle and a circle in an RRH coverage range.

The overlapping area between the user terminal 110 and the RRH may be used for determining a period in which the user terminal 110 may stay in the coverage of the RRH.

An overlapping area (O_{c,h}=Area(Cₑ)∩Area(Cₕ) between two circles Cₑ and Cₕ expressed as Oe,h may be determined based on a distance between centers of two circles, which is expressed as d_{c} and radiuses of two circles.

In an embodiment, the overlapping area O_{e,h} may be shown as in <Equation 16>.

$$\text{?} \qquad [ Equation 16 ]$$

$$\text{?} \text{indicates text missing or illegible when filed}$$

Here, 0≤O_{c,h}≤1, and Φ_{ρ} and Φ_{R} values may be expressed as in <Equation 17> and <Equation 18>.

$$\text{?} \qquad [ Equation 17 ]$$

$$\text{?} \qquad [ Equation 18 ]$$

$$\text{?} \text{indicates text missing or illegible when filed}$$

Here, ρ represents the radius of the expected area circle Ce and R represents the radius of the RRH coverage range circle Cₕ. Since Cₑ<Cₕ, Cₑ may be completely present inside Cₕ.

In this case, an overlapped area may be equal to Area (Cₑ) and may be shown as in <Equation 19>.

Area(Cₑ)=πρ² [Equation 19]

Here, ρ represents a radius of the circle Cₑ.

In an embodiment, in respect to the virtual reward calculation, maximizing the overlapping area O_{e,h} the expected area of the user terminal i and the coverage range of RRH j at the time t may be the same as maximizing an association duration of the user terminal 110 and the RRH.

The overlapping area may be used for calculating the virtual reward r^{t}ᵥₖ for all actions k available at the time t when a certain exploitation condition is generated.

Further, the virtual reward function may include a proximity of the user terminal i and the RRH j, and a directional displacement of the user terminal.

In an embodiment, the proximity P_{i,j} may be shown as in <Equation 20>.

$$\text{?} \qquad [ Equation 20 ]$$

$$\text{?} \text{indicates text missing or illegible when filed}$$

Here, D_{i,j} represents the distance between the user terminal i and the RRH j and R represents the coverage range of the RRH.

The proximity may indicate how close the user terminal i is to the RRH j. That is, the higher the proximity is, the closer the user terminal 110 is to the corresponding RRH.

Further, the directional displacement may be related to the direction [symbol] _{i,j} calculated in the state space. In this case, the directional displacement Λ_{i,j} of the user terminal i facing the RRH j may be shown as in <Equation 21>.

$${Λ}_{i , j} = \frac{{D}_{i , j}^{t - 1} - {D}_{i , j}^{t}}{{v}_{i}} \qquad [ Equation 21 ]$$

Here, vᵢ represents the velocity of the user terminal i. A positive value of Λ_{i,j} indicates that the user terminal i moves toward the RRH j and a negative value indicates that the user terminal i moves in the external direction.

When the values of the proximity and the directional displacement of the overlapping area are maximized, a possibility that the user terminal 110 will stay below the corresponding RRH longer may increase.

Therefore, the virtual reward for each candidate RRH at all determination time t may be shown as in <Equation 22>.

$$\text{?} \qquad [ Equation 22 ]$$

$$\text{?} \text{indicates text missing or illegible when filed}$$

The virtual reward may be mapped to the actual reward and used for calculating the bias value b.

The bias may be used for calculating a new reward for a certain exploitation step as expressed in <Table 2>.

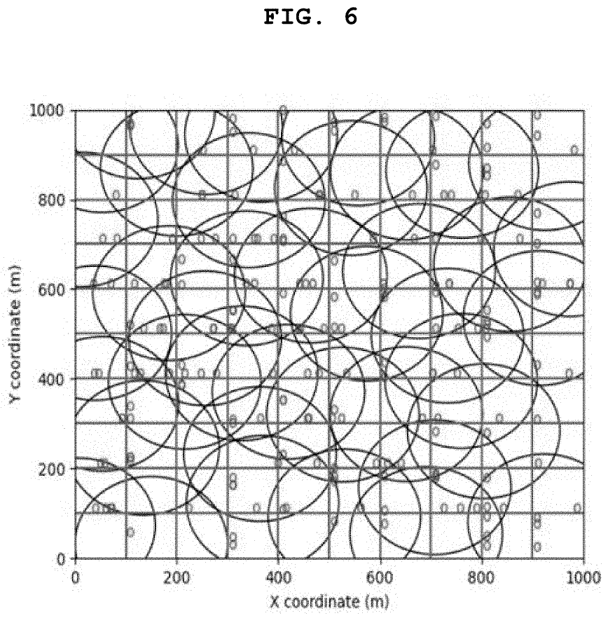

FIG. 6 is a diagram illustrating an example of a network layout according to an embodiment of the present disclosure.

Referring to FIG. 6, for performance evaluation, a fuzzy logic-based handover parameter optimization and RL-based RRH selection with the acceleration technique (FLRL-AC) may be evaluated.

In order to evaluate the performance of the scheme according to the present disclosure, the scheme may be compared with the existing SNR based handover (SBH) scheme.

Further, fuzzy logic based TTT optimization and the performance of the acceleration technique of the RL model may be evaluated.

To this end, two schemes: FLRL and RL-AC may be implemented.

Conventional SNR-based handover (SBH) selects an RRH for user terminal connection based on a highest SNR.

In the case of the present disclosure, the same handover trigger condition as the action may be used.

RL-AC may indicate RL model based RRH selection using an acceleration technique with no fuzzy logic. In this case, the TTT is not optimized in the RL-AC.

The acceleration technique according to the present disclosure may be applied to FLRL-AC.

Further, the RL-AC indicates efficiency of RL based user terminal association only by the acceleration technique.

In FLRL, the acceleration technique is not used for RL based RRH selection. Here, fuzzy logic based TTT optimization may be used. This technique may be used for evaluating the performance of the fuzzy logic based TTT optimization algorithm jointly with the RL based user terminal association technique.

As an exemplary simulation environment, a C-RAN environment constituted by a specific number of small RRHs including a 1000 m×1000 m square area and randomly arranged. However, the simulation environment is just one example, and is not limited.

Coverage ranges of all RRHs are the same as each other, and may be overlapped with different neighboring RRHs expressed by circular areas, respectively. The number of RRHs may be basically set to 50.

Transmission power of the RRH may be set to 30 dBm and noise power may be set to −77 dBm.

In <Equation 1>, a parameter for pathloss calculation may correspond to a carrier frequency of 28 GHz and LOS communication. The bandwidth allocated to the RRH may be set to 500 MHz.

The number of user terminals 110 which the RRH may simultaneously service may be set to s 10.

The user terminal 110 may be randomly distributed in the simulation area, and may move in the network by using a modified random walk model.

The number of user terminals 110 and the velocity of the user terminal 110 may be 200 and 6 m/s, respectively.

In the policy of the RL model, the value may be initially set to 1 and attenuation may be set to 0.99. A minimum value may be set to 0.1.

Simulation parameters used in the present disclosure may be shown as in <Table 3>.

| Parameters | Values | |
|---|---|---|
| Size of network area | (1000 × 1000) | m |
| RRH transmit power | 30 | dBm |
| Noise power | −77 | dBm |
| Bandwidth | 500 | MHz |
| Parameters for path loss | α = 61.4, β = 2 | |
| RRH coverage range | 150 | m |

| | |
|---|---|
| Number of RRH | 50 (default) |
| Number of users | 200 (default) |
| User velocity | 6 m/s (default) |
| User capacity of RRH | 10 |
| Number of iterations | 10000 |
| Epsilon (e) | [1, 0.1, 0.99] |

A network layout having 50 RRHs and 200 user terminals may be shown as in FIG. 6.

A black line indicates the application range of each RRH and a red circle indicates the user terminal 110 of the network. A blue straight line indicates the movement path of the user terminal 110. The user terminal 110 may move through a straight line by modified random walking.

The performance of the method according to the present disclosure may be evaluated by considering various parameters.

An evaluation result using another parameter may be confirmed in terms of the number of handover times per user terminal and an average reward acquired by comparing with another scheme.

The average reward indicates an average connection residual time for the user terminal-RRH connection.

According to the present disclosure, since the connection duration is maintained longer while maintaining QoS, and the number of handovers is reduced, two metrics may accurately reflect the performance of the scheme according to the present disclosure rather than the compared scheme.

Further, the user terminal-RRH association period may be used as a metric for evaluating the performance of QoS satisfaction.

As can be known in the QoS model, a period in which the user terminal 110 obtains a larger SNR than the threshold may indicate the QoS satisfaction of the user terminal 110. Therefore, the handover may be triggered when the received SNR is smaller than the threshold.

Therefore, maximizing the user terminal-RRH association period may be similar to maximizing the QoS satisfaction of the user terminal 110.

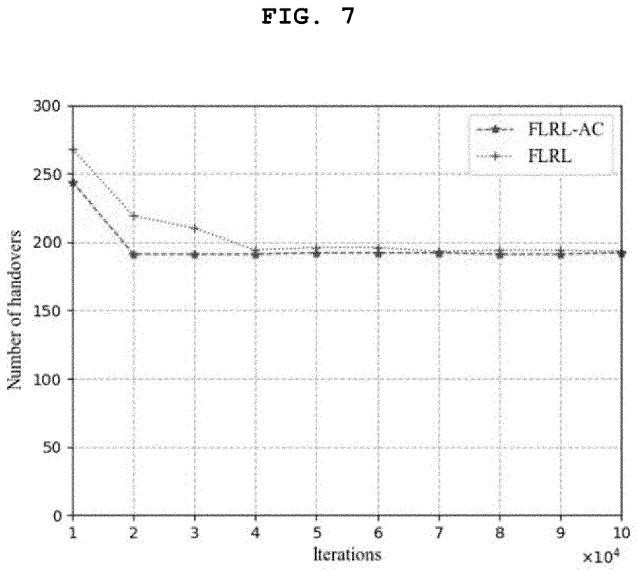

FIG. 7 is a diagram illustrating a coverage performance of a reinforcement learning model for a handover number according to an embodiment of the present disclosure.

Referring to FIG. 7, for convergence evaluation, convergence of FLRL-AC may be analyzed only by FLRL. A main reason may be to prove an advantage when the acceleration technique according to the present disclosure is used.

To this end, as the number of episodes increases, the total number of handover times and the average reward may be confirmed.

Two schemes may be executed with respect to 100000 repetitions for maintaining a basic network parameter and the simulation.

Convergence of the total number of handovers per 10000 episodes and the RL algorithm may be confirmed, and it may be confirmed that both algorithms consequently reach the convergence, but FLRL-AC is converged faster than FLRL.

Further, it may be confirmed that while FLRL-AC is converged to 20000 episodes, FLRL is converged after 40000 episodes. This result proves the advantage of a virtual reward based acceleration technique according to the present disclosure.

Since the agent of the BBU controller 130 learns a method for taking a better measure by using the acceleration technique, the total number of handovers may also be reduced.

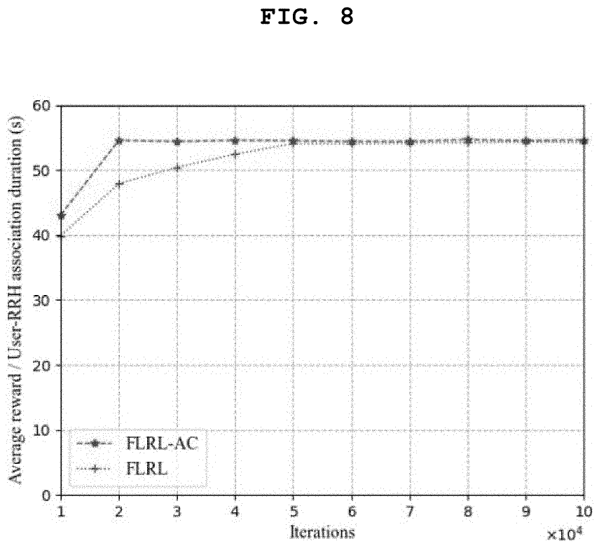

FIG. 8 is a diagram illustrating a coverage performance of a reinforcement learning model for an average compensation according to an embodiment of the present disclosure.

Referring to FIG. 8, the comparison of the convergence performance of the RL model in terms of the average reward may be confirmed.

The average reward may indicate an average duration of the user terminal-RRH connection indicating a duration in which the user terminal 110 is connected to a specific RRH as expressed in the reward function of the RL model.

FLRL-AC may reach the convergence faster and thus have more excellent performance than FLRL and show a similarity to the previous result.

Initially, due to the exploration step, the performance may be slowly enhanced. When the exploration is started, the agent calculates the virtual reward to start to take the measure. Therefore, the performance may be enhanced faster.

FLRL-AC may be converged to 20000 episodes by using the acceleration technique.

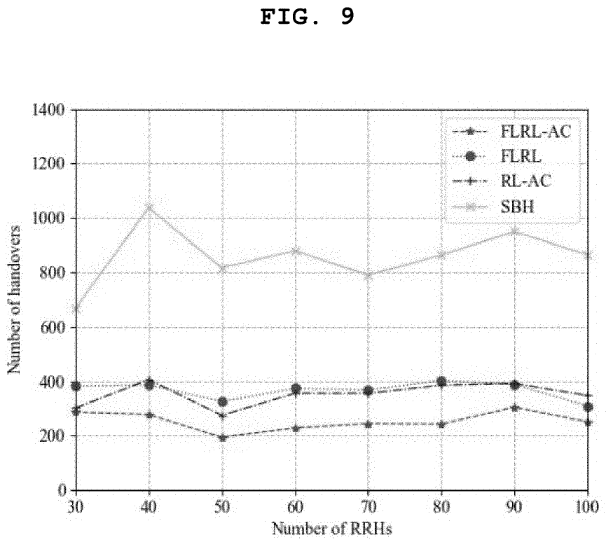

FIG. 9 is a diagram illustrating a handover number-of-times performance graph for the number of RRHs according to an embodiment of the present disclosure.

Referring to FIG. 9, in respect to various densities of the RRH, 8 values of 30, 40, 50, 60, 70, 80, 90, and 100 may be selected for the number of RRHs and each instance may be executed for 10000 repetitions (time units).

The number of handovers per user terminal per user terminal may be confirmed while maintaining the number of user terminals 110 and the movement velocity of the user terminal 10 as basic values.

In this case, it may be confirmed that the number of handovers for FLRL-AC according to the present disclosure is remarkably smaller than the number of handovers for FLRL, RL-AC, and SBH in the related art.

In this result, an advantage of using both the FL based TTT optimization and the acceleration technique may be implemented. It may be confirmed that the number of handover times is the smallest when the number of RRHs is 50.

The dens of the RRH may influence the number of handover times. The reason is that when a predetermined number of RRHs are arranged in the same region, the RL agent has more options capable of the best RRH.

However, when there are 30 RRHs, the user terminal may move below application ranges of a smaller number of RRHs and the agent may select the RRH for the user terminal 110 which may not stay any longer.

Further, in the C-RAN environment, when the density is higher than 50, the number of handover times may slightly increase. The fluctuation may be caused by the exploration period of the agent until the exploitation step starts.

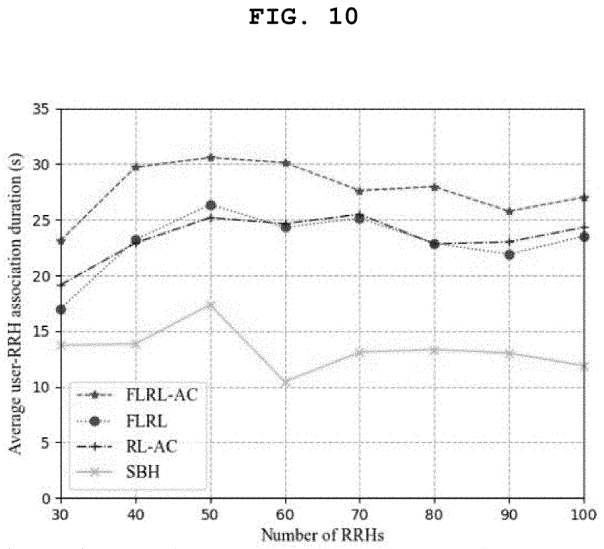

FIG. 10 is a diagram illustrating a relevant period performance graph of an average user terminal and RRH for the number of RRHs according to an embodiment of the present disclosure.

Referring to FIG. 10, the average user terminal-RRH association period of the proposed scheme may be compared while maintaining the RRH density and other parameters to be the same.

It may be confirmed that FLRL-AC is more excellent in performance than all other compared schemes in terms of the average user terminal-RRH connection period.

It may be confirmed that when the number of RRHs increases from 30 to 50, the duration increases and as the number of RRHs increases, the duration decreases again.

The reason may be that when there are 30 RRHs, the user terminal 110 may move below application ranges of a smaller number of RRHs and the agent may select the RRH for the user terminal 110 which may not stay any longer.

In other words, when the agent selects another RRH and learns the reward, the duration may start to decrease for 50 RRHs or more due to an exploration period of the agent.

When the candidate RRH set increases, a longer time may be required for the agent to converge to the best action.

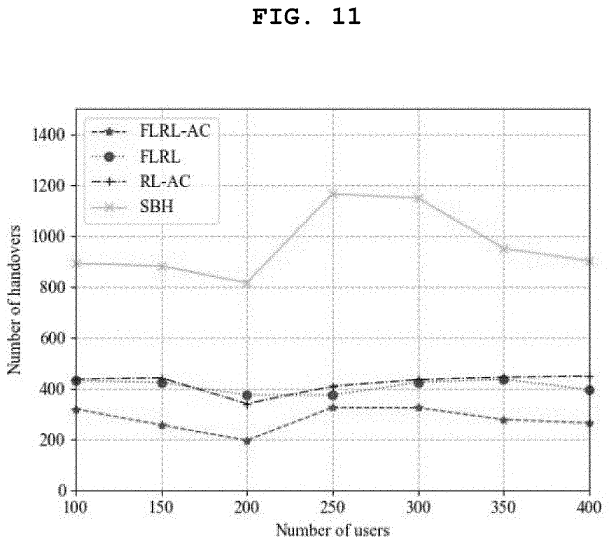

FIG. 11 is a diagram illustrating a handover number-of-times performance graph for the number of user terminals according to an embodiment of the present disclosure.

Referring to FIG. 11, the number of user terminals 110 may be changed in the C-RAN environment in order to verify the performance of the scheme according to the present disclosure in terms of the number of handover times in respect to various user terminal numbers.

In basic network setting in which the number of RRHs is 50, the number of user terminals 110 may be changed to 100, 150, 200, 250, 300, 350, and 400.

It may be confirmed that FLRL-AC according to the present disclosure has more excellent performance than another algorithm in terms of the number of handovers per user terminal in respect to various user terminal numbers.

Initially, it may be confirmed that the number of handover times for RL-AC is smaller than that in FLRL, but the number of user terminals 110 increases to 350 and the number of handover times slightly increases.

Therefore, it may be confirmed that the acceleration technique is slow as the number of user terminals of the network increases.

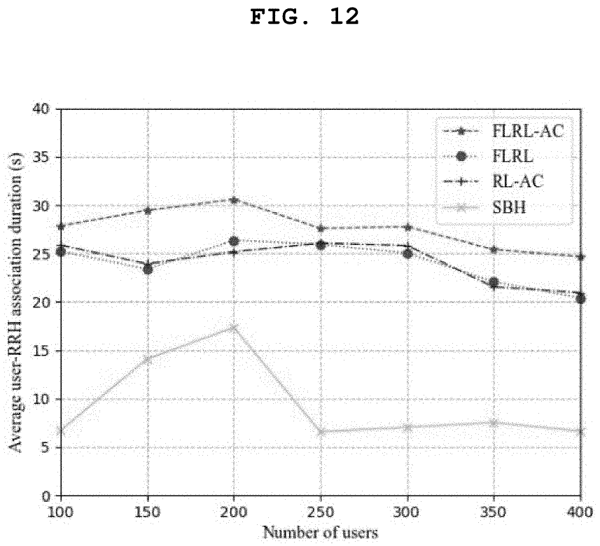

FIG. 12 is a diagram illustrating a relevant period performance graph of an average user terminal and RRH for the number of user terminals according to an embodiment of the present disclosure.

Referring to FIG. 12, the performance of the average user terminal-RRH connection period may be confirmed.

It may be confirmed that FLRL-AC according to the present disclosure surpasses all other compared schemes, and the average duration is the highest in basic setting when the number of user terminals 110 is 200.

It may be confirmed that the performance slightly decreases as the number of user terminals 110 of the network increases to 200 or more.

It may be confirmed that the performances of FLRL and RL-AC are almost similar in respect to the average user terminal-RRH connection period having various numbers of user terminals 110.

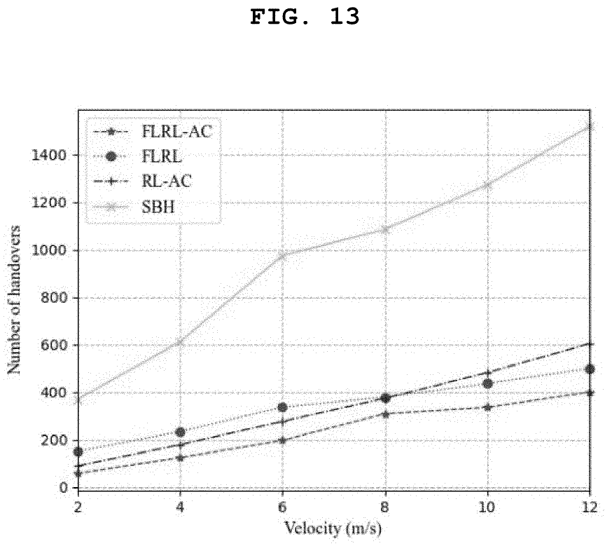

FIG. 13 is a diagram illustrating a handover number-of-times performance graph for a movement speed of a user terminal according to an embodiment of the present disclosure.

Referring to FIG. 13, it may be confirmed that the velocity of the user terminal 110 exerts an important influence on the performance of the method according to the present disclosure in respect to the movement velocities of various user terminals 110.

The handover control parameter may directly depend on the movement velocity of the user terminal 110.

Therefore, the performance of the method according to the present disclosure may be confirmed while changing the movement velocity of the user terminal 110 by considering a low velocity, a medium velocity, and a high velocity of the user terminal 110.

It may be confirmed that FLRL-AC according to the present disclosure shows a better performance than other scheme in terms of the number of handover times per user terminal.

It may be confirmed that the number of handover times of RL-AC is first smaller than that of FLRL.

When the velocity increases, the number of handover times for RL-AC may increase because the movement velocity of the user terminal 110 is not directly considered.

Since handover triggering is performed by FL based on the user terminal-RRH distance and the movement velocity of the user terminal 110, the TTT may be optimized to both FLRL-AC and RL-AC as the velocity increases.

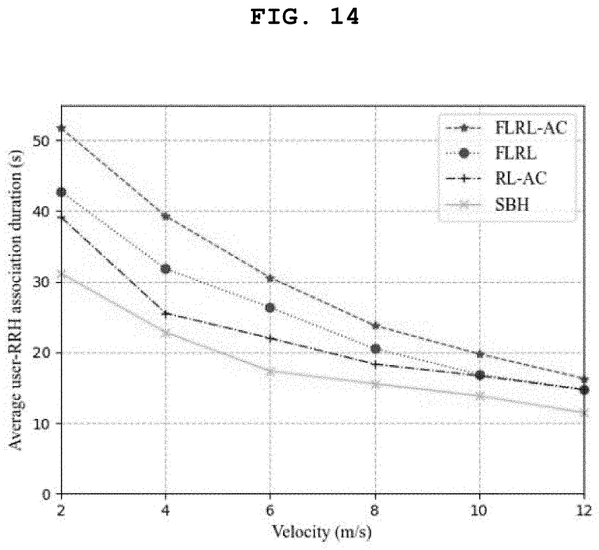

FIG. 14 is a diagram illustrating a relevant period performance graph of an average user terminal and RRH for a movement speed of a user terminal according to an embodiment of the present disclosure.

Referring to FIG. 14, the average user terminal-RRH connection period according to the movement velocities of various user terminals 110 may be confirmed.

It may be confirmed that the connection duration decreases as the movement velocity of the user terminal 110 increases.

As the movement velocity increases, the user terminal 110 may be very rapidly distant from the coverage area of the RRH, and the received SNR may be very low.

Therefore, when the handover condition is triggered and all conditions are satisfied, the target RRH 124 may be selected by the agent of the BBU controller 130.

It may be observed that FLRL-AC according to the present disclosure shows a more excellent performance than all other schemes due to the TTT optimization and the acceleration technique.

According to the present disclosure, the user terminal 110 may optimize the handover trigger condition and the RRH selection in order to reduce frequent handover.

First, a fuzzy logic based solution may be implemented in order to adjust a time required for maintaining the connection with the serving RRH 122 after reaching a specific threshold.

The RL model may be used, which selects the target RRH 124 to maintain the connection longer when the handover event occurs.

The acceleration technique may be used, which is based on future location prediction of the user terminal 110 for faster convergence of the RL model.

According to the preset invention, the virtual reward is provided during each RRH selection period to solve the exploration-exploitation trade-off in the RL model.

In an uncertain situation, the virtual reward and the actual reward may be mapped for the RRH selection. When the virtual reward is integrated, the RL model may be converged faster.

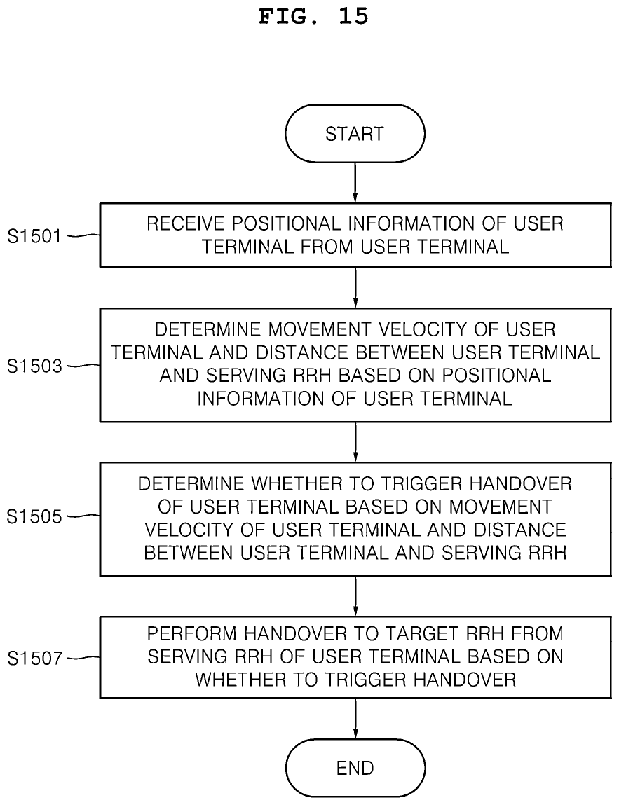

FIG. 15 is a diagram illustrating a method for user association based on fuzzy logic and accelerated reinforcement learning in a dense cloud wireless network according to an embodiment of the present disclosure.

Referring to FIG. 15, step S1501 is a step of receiving positional information of the user terminal 110. In an embodiment, the positional information may be received from the user terminal 110 or the serving RRH 122.

Step S1503 is a step of determining the movement velocity of the user terminal 110 and the distance between the user terminal 110 and the serving RRH 122 based on the positional information of the user terminal 110.

Step S1505 is a step of determining whether to trigger the handover of the user terminal 110 based on the movement velocity of the user terminal 110 and the distance between the user terminal 110 and the serving RRH 122.

In an embodiment, the movement velocity of the user terminal 110 and the distance between the user terminal 110 and the serving RRH 122 are applied to the fuzzy logic function to adjust a time-to-trigger (TTT) value indicating a connection maintenance time between the user terminal 110 and the serving RRH 122 after the received signal strength for the signal received from the user terminal 110 is smaller than the threshold, and determine whether to trigger the handover of the user terminal 110 based on the adjusted TTT value.

Step S1507 is a step of performing the handover to the target RRH 124 from the serving RRH 122 of the user terminal 110.

In an embodiment, the proximity of the user terminal 110 and the serving RRH may be calculated based on the distance between the user terminal 110 and the serving RRH 122, and the coverage of the serving RRH.

In an embodiment, the proximity of the user terminal 110 and the serving RRH may be calculated based on the distance between the user terminal 110 and the serving RRH 122, and the coverage of the serving RRH.

Further, the proximity of the user terminal 110 and the serving RRH 122 and the directional displacement of the user terminal are applied to the RL model to determine the target RRH 124 among multiple candidate RRHs and perform the handover to the determined target RRH 124.

In an embodiment, the virtual reward of the RL model may be generated based on the expected location of the user terminal 110, and the proximity of the user terminal 110 and the serving RRH 122 and the directional displacement of the user terminal 110.

Further, a virtual learning model may be converged by mapping the virtual reward and the actual reward of the RL model.

Further, the target RRH 124 among multiple candidate RRHs may be determined based on the converged RL model and the handover to the determined target RRH 124 may be performed.

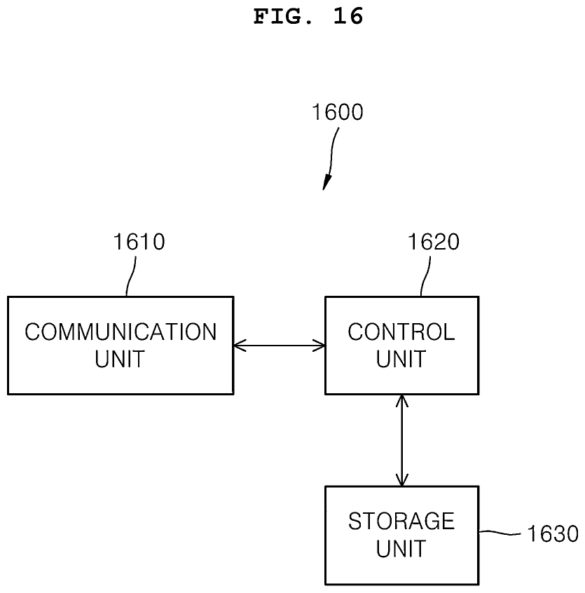

FIG. 16 is a diagram illustrating a functional configuration of an apparatus 1600 for user association based on fuzzy logic and accelerated reinforcement learning in a dense cloud wireless network according to an embodiment of the present disclosure. In an embodiment, the user association apparatus 1600 of FIG. 16 may include the BBU controller 130 in each step of FIG. 4.

Referring to FIG. 16, the user association apparatus 1600 may include a communication unit 1610, a control unit 1620, and a storage unit 1630.

The communication unit 1610 may receive positional information of the user terminal 110. In an embodiment, the positional information may be received from the user terminal 110 or the serving RRH 122.

In an embodiment, the communication unit 1610 may include at least one of a wired communication module and a wireless communication module. The entirety or a part of the communication unit 1610 may be referred to as a ‘transmission unit’, a ‘reception unit’, or a ‘transceiver’.

The control unit 1620 may determine the movement velocity of the user terminal 110 and the distance between the user terminal 110 and a serving remote radio head (RRH) based on the positional information of the user terminal 110, determine whether to trigger the handover of the user terminal 110 based on the movement velocity of the user terminal 110 and the distance between the user terminal 110 and the serving RRH 122, and perform the handover to the target RRH 124 from the serving RRH 122 of the user terminal 110 based on whether to trigger the handover.

In an embodiment, the control unit 1620 may calculate the proximity of the user terminal 110 and the serving RRH 122 based on the distance between the user terminal 110 and the serving RRH 122 and the coverage of the serving RRH 122, and calculate the directional displacement of the user terminal 110 for the serving RRH 122 based on a change amount of the distance between the user terminal 110 and the serving RRH 122 and the movement velocity of the user terminal 110.

Further, the control unit 1620 applies the user terminal 110 and the serving RRH 122 and the directional displacement of the user terminal 110 to the RL model to determine the target RRH 124 among multiple candidate RRHs and perform the handover to the determined target RRH 124.

In an embodiment, the control unit 1620 may include at least one processor or micro processor, or may be a part of the processor. Further, the control unit 1620 may be referred to as a communication processor (CP). The control unit 1620 may control an operation of the user association apparatus 1600 according to various exemplary embodiments of the present disclosure.

The storage unit 1630 may store the fuzzy logic function and the RL model.

In an embodiment, the storage unit 1630 may be configured by a volatile memory, a non-volatile memory, or a combination of the volatile memory and the non-volatile memory. In addition, the storage unit 1630 may provide stored data according to a request from the control unit 1620.

Referring to FIG. 16, the user association apparatus 1600 may include a communication unit 1610, a control unit 1620, and a storage unit 1630. In various exemplary embodiments of the present disclosure, the components described in FIG. 16 are not required, so the apparatus 1600 may be implemented to have components which are more than the components described in FIG. 16 or less therethan.

The above description just illustrates the technical spirit of the present disclosure and various changes and modifications can be made by those skilled in the art without departing from an essential characteristic of the present disclosure.

Various exemplary embodiments disclosed herein may be performed regardless of the order, and may be performed simultaneously or separately.

In an embodiment, at least one step may be omitted or added in each drawing described herein, or performed in a reverse order or performed simultaneously.

The embodiments disclosed herein are provided for illustrative purposes only but not intended to limit the technical spirit of the present disclosure. The scope of the present disclosure is not limited to the embodiments.

The protection scope of the present disclosure should be construed based on the claims and it should be appreciated that the technical spirit included within the scope equivalent to the claims belongs to the present disclosure.

What is claimed is:

1. A method for user association based on fuzzy logic and accelerated reinforcement learning for a dense cloud wireless network, the method comprising:
(a) receiving positional information of a user terminal;
(b) determining a movement velocity of the user terminal and a distance between the user terminal and a serving remote radio head (RRH) based on the positional information of the user terminal;
(c) determining whether to trigger handover of the user terminal based on the movement velocity of the user terminal and the distance between the user terminal and the serving RRH; and
(d) performing handover to a target RRH from the serving RRH of the user terminal based on whether to trigger the handover.

2. The method for user association based on fuzzy logic and accelerated reinforcement learning for a dense cloud wireless network of claim 1, wherein step c) above includes
adjusting a time-to-trigger (TTT) value indicating a connection maintenance time between the user terminal and the serving RRH after a received signal strength for a signal received from the user terminal is smaller than a threshold by applying the movement velocity of the user terminal and the distance between the user terminal and the serving RRH to a fuzzy logic function, and
determining whether to trigger the handover of the user terminal based on the adjusted TTT value.

3. The method for user association based on fuzzy logic and accelerated reinforcement learning for a dense cloud wireless network of claim 1, wherein step (d) above includes
calculating a proximity of the user terminal and the serving RRH based on the distance between the user terminal and the serving RRH and a coverage of the serving RRH, and calculating a directional displacement of the user terminal for the serving RRH based on a change amount of the distance between the user terminal and the serving RRH and the movement velocity of the user terminal,
determining the target RRH among multiple candidate RRHs by applying the proximity of the user terminal and the serving RRH and the directional displacement of the user terminal to a reinforce learning model, and
performing the handover to the determined target RRH.

4. The method for user association based on fuzzy logic and accelerated reinforcement learning for a dense cloud wireless network of claim 3, wherein step (d) above includes
generating a virtual reward of the RL model based on an expected location of the user terminal, and the proximity of the user terminal and the serving RRH and the directional displacement of the user terminal,
converging a virtual learning model by mapping a virtual reward and an actual reward of the RL model,
determining the target RRH among the multiple candidate RRHs based on the converged RL model, and
performing the handover to the determined target RRH.

5. An apparatus for user association based on fuzzy logic and accelerated reinforcement learning for a dense cloud wireless network, the apparatus comprising:
a communication unit receiving positional information of a user terminal; and
a control unit determining a movement velocity of the user terminal and a distance between the user terminal and a serving remote radio head (RRH) based on the positional information of the user terminal,
determining whether to trigger handover of the user terminal based on the movement velocity of the user terminal and the distance between the user terminal and the serving RRH, and
performing handover to a target RRH from the serving RRH of the user terminal based on whether to trigger the handover.

6. The apparatus for user association based on fuzzy logic and accelerated reinforcement learning for a dense cloud wireless network of claim 5, wherein the control unit
adjusts a time-to-trigger (TTT) value indicating a connection maintenance time between the user terminal and the serving RRH after a received signal strength for a signal received from the user terminal is smaller than a threshold by applying the movement velocity of the user terminal and the distance between the user terminal and the serving RRH to a fuzzy logic function, and
determines whether to trigger the handover of the user terminal based on the adjusted TTT value.

7. The apparatus for user association based on fuzzy logic and accelerated reinforcement learning for a dense cloud wireless network of claim 5, wherein the control unit
calculates a proximity of the user terminal and the serving RRH based on the distance between the user terminal and the serving RRH and a coverage of the serving RRH, and calculates a directional displacement of the user terminal for the serving RRH based on a change amount of the distance between the user terminal and the serving RRH and the movement velocity of the user terminal,
determines the target RRH among multiple candidate RRHs by applying the proximity of the user terminal and the serving RRH and the directional displacement of the user terminal to a reinforce learning model, and
performs the handover to the determined target RRH.

8. The apparatus for user association based on fuzzy logic and accelerated reinforcement learning for a dense cloud wireless network of claim 7, wherein the control unit
generates a virtual reward of the RL model based on an expected location of the user terminal, and the proximity of the user terminal and the serving RRH and the directional displacement of the user terminal,
converges a virtual learning model by mapping a virtual reward and an actual reward of the RL model,
determines the target RRH among the multiple candidate RRHs based on the converged RL model, and
performs the handover to the determined target RRH.
